(19) United States
(12) Patent Application Publication
(10) Pub. No.: US 2013/0268467 A1
(43) Pub. Date: Oct. 10, 2013

(54) TRAINING FUNCTION GENERATING DEVICE, TRAINING FUNCTION GENERATING METHOD, AND FEATURE VECTOR CLASSIFYING METHOD USING THE SAME

(71) Applicants: Sanghun YOON, Daejeon (KR); Chun-Gi Lyuh, Daejeon (KR); Ik Jae Chun, Daejeon (KR); Jung Hee Suk, Daejeon (KR); Tae Moon Roh, Daejeon (KR)

(72) Inventors: Sanghun YOON, Daejeon (KR); Chun-Gi Lyuh, Daejeon (KR); Ik Jae Chun, Daejeon (KR); Jung Hee Suk, Daejeon (KR); Tae Moon Roh, Daejeon (KR)

(73) Assignee: Electronics and Telecommunications Research Institute, Daejeon (KR)

(21) Appl. No.: 13/620,319

(22) Filed: Sep. 14, 2012

(30) Foreign Application Priority Data
Apr. 9, 2012 (KR) 10-2012-0036754

(51) Int. Cl. G06F 15/18

(52) U.S. Cl. 706/12

(57) ABSTRACT

Provided is a training function generating method. The method includes: receiving training vectors; calculating a training function from the training vectors; comparing a classification performance of the calculated training function with a predetermined classification performance and recalculating a training function on the basis of a comparison result, wherein the recalculating of the training function includes: changing a priority between a false alarm probability and a miss detection probability of the calculated training function; and recalculating a training function according to the changed priority.

### CROSS-REFERENCE TO RELATED APPLICATIONS

This U.S. non-provisional patent application claims priority under 35 U.S.C. §119 of Korean Patent Application No. 10-2012-0036754, filed on Apr. 9, 2012, the entire contents of which are hereby incorporated by reference.

### BACKGROUND OF THE INVENTION

The present invention disclosed herein relates to a training function generating device, a training function generating method, and a feature vector classifying method using the same.

Classifying feature vectors is one of the most important factors for determining the performance and speed of a recognition technique. Among methods for classifying and recognizing objects by using machines, a method using a Support Vector Machine (SVM) is the most commonly used, due to its excellent performance.

However, in order to show high performance by using a non-linear kernel SVM, it is necessary to store a large number of support vectors. Also, a complex calculation is required between an input vector and a support vector. In order to process the complex calculation in real time, since hardware for parallel processing is consumed, there are many difficulties in implementing the SVM as an embedded system.

In order to simplify such a calculation complexity, methods for reducing the number of typical support vectors have been used. However, the methods have limitations in that classification performance is significantly deteriorated. Accordingly, a technique to remove the limitations is required.

### SUMMARY OF THE INVENTION

The present invention provides excellent classification performance with lower computational amount through a training function generating device, a training function generating method, and a feature vector classifying method using the same.

Embodiments of the present invention provide a training function generating method including: receiving training vectors; calculating a training function from the training vectors; comparing a classification performance of the calculated training function with a predetermined classification performance and recalculating a training function on the basis of a comparison result, wherein the recalculating of the training function includes: changing a priority between a false alarm probability and a miss detection probability of the calculated training function; and recalculating a training function according to the changed priority.

In some embodiments, the classification performance of the calculated training function may be determined by the false alarm probability and the miss detection probability of the calculated training function.

In other embodiments, the classification performance of the calculated training function may be a miss detection probability when the calculated training function has a predetermined false alarm probability.

In still other embodiments, the calculated training function may be a linear function.

In even other embodiments, the calculating of the training function may use a mean square error corresponding to the training vectors.

In yet other embodiments, the calculated function may have a minimum value of the mean square error.

In further embodiments, the recalculating of the training function further may include receiving new training vectors, wherein the recalculated training function is calculated from the received new training vectors according to the changed priority.

In still further embodiments, the recalculated training function may be calculated based on a storage coefficient for the training vectors and the newly added training vector.

In even further embodiments, the calculating of the training function from the training vectors may include: extending the received training vectors; and calculating the training function from the extended training vectors.

In other embodiments of the present invention, a feature vector classifying method includes: generating a training function; calculating a decision value of a feature vector by using the generated training function; and comparing the calculated decision value of the feature vector with a class threshold in order to classify the feature vector, wherein the generating of the training function includes calculating an initial training function from initial training vectors, comparing a classification performance of the initial training function with a predetermined classification performance, and recalculating a training function on the basis of a comparison result; and the recalculating of the training function includes changing a priority between a false alarm probability and a miss detection probability of the calculated training function, and recalculating a training function according to the changed priority.

In some embodiments, the recalculating of the initial training function from the initial training function may include: adding a new training vector; and calculating an initial training function on the basis of a storage coefficient for the initial training vectors and the newly-added training vectors.

In other embodiments, the classification performance of the initial training function may be determined by the false alarm probability and the miss detection probability of the initial training function.

In still other embodiments of the present invention, a training function generating device includes: a training function calculating unit calculating an initial training function by using a predetermined priority; a loop determining unit determining whether to recalculate a training function by comparing a classification performance of the initial training function with a predetermined classification performance; and a training function generating unit outputting a training function calculated by the training function calculating unit, wherein the loop determining unit compares the classification performance of the initial training function with the predetermined classification performance and changes the predetermine priority according to a comparison result.

In some embodiments, the training function calculating unit may calculate the initial training function by using a mean square error corresponding to training vectors.

In other embodiments, the loop determining unit may determine the classification performance of the calculated initial training function by using a miss detection probability of when the calculated initial training function has a predetermined false alarm probability.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a flowchart illustrating a feature vector classifying method according to an embodiment of the present invention;

FIG. 2 is a view illustrating a training function generating device according to an embodiment of the present invention;

FIG. 3 is a flowchart illustrating a training function generating method according to an embodiment of the present invention;

FIG. 4 is a flowchart illustrating a training function generating method according to another embodiment of the present invention;

FIG. 5 is a graph illustrating the probability distribution of training vectors when a positive vector has the same significance as a negative vector;

FIG. 6 is a graph illustrating the probability distribution of training vectors when a negative vector is prioritized;

FIG. 7 is a table illustrating parameters, which are used for measuring computational complexity by using a HOG-LBP descriptor in order to experiment the effects of the present invention;

FIG. 8 is a table illustrating the number of multiplications, which is reduced when HOG and HOG-LBP descriptor are used with the parameters of FIG. 7;

FIG. 9 is a graph illustrating an experimental result of a miss detection rate for false positive per window by changing the significance; and

FIG. 10 is a graph illustrating an experimental result of a miss detection rate for false positive per window by changing the significance differently.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

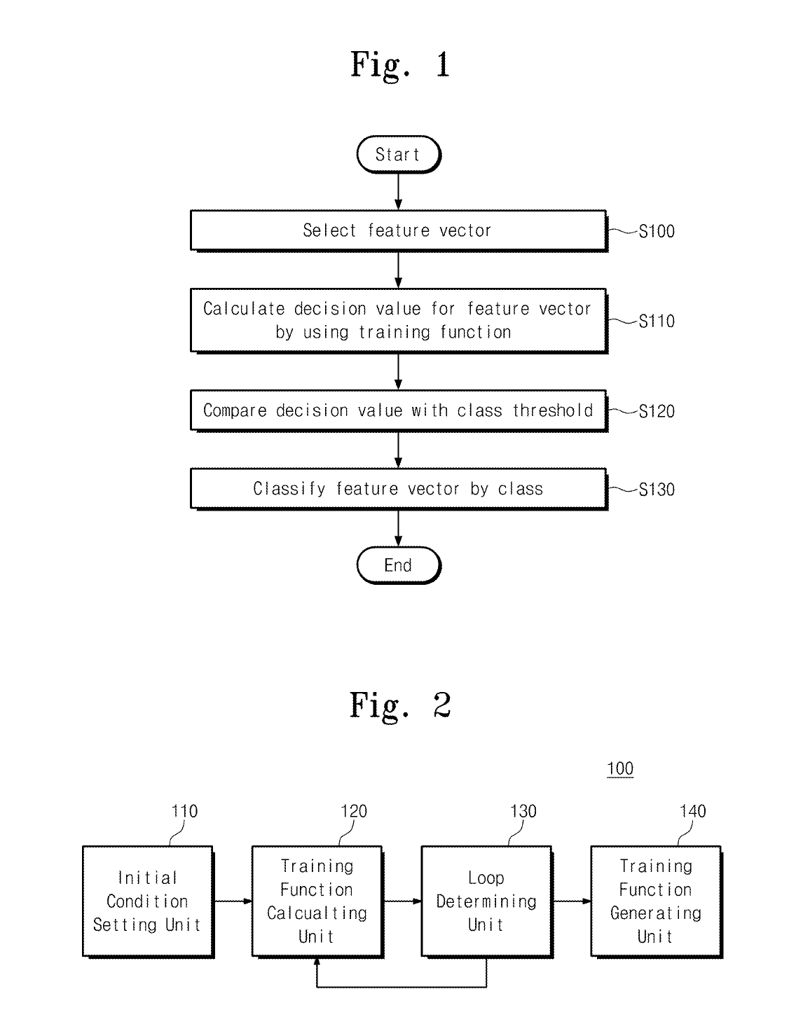

FIG. 1 is a flowchart illustrating a feature vector classifying method according to an embodiment of the present invention. According to the feature vector classifying method, feature vectors are classified by their class through a training function. Therefore, in order to increase the efficiency of the feature vector classifying method, a training function having low computational amount and high classification performance is required. Referring to FIG. 1, a method of classifying the class of a feature vector is as follows.

In operation S100, a feature vector to be classified is specified. The feature vector x may be expressed as the following Equation 1.

x=(f₁,f₂, . . . ,f_{d}) i.e. x εR^{d} [Equation 1]

The feature vector has d features. Each feature of the feature vector represents a pre-normalized feature to classify vectors. The feature vector is classified by their class through each feature.

For example, if the feature vector represents an image screen, each feature may include the distribution of colors and the clarity of boundaries in an image. At this point, the class may relate to whether an image screen is the face of a man or not. This is just one example, and thus, the present invention is not limited thereto.

In operation S110, a decision value to the feature vector is calculated by a training function. This process may be expressed as the following Equation 2.

D=f(x) [Equation 2]

where D is a decision value of a feature vector calculated by a training function, x is a feature vector to be classified, and f is a training function.

The training function is generated using training vectors in order to classify the classes of the feature vectors. The training vectors are pre-examined sample vectors. A method for generating a training function will be described in more detail with reference to FIG. 2.

In operation S120, the decision value calculated in operation S110 is compared with a class threshold. The class threshold is a reference value that is predetermined by the decision value in order to classify a class.

In operation S130, the feature vectors are classified into classes on the basis of the comparison result of operation S120. For example, it is assumed that the class of a feature vector has two classes (e.g., a first class and a second class). At this point, if the decision value is more than or equal to the class threshold, the feature vector is classified as the first class, and if not, the feature vector is classified as the second class.

As mentioned above, the feature vector classifying method according to this embodiment classifies the class of a feature vector through the decision value obtained by calculating the training function. Accordingly, in order to improve the performance of the feature vector classifying method, a training function having low computational amount and high classification performance needs to be generated.

In general, the number of training vectors used to generate a training function is very large. Therefore, in order to achieve fast and efficient classification, a computational amount required for a process that calculates a decision value through a training function and a computational amount required for a process that generates a training function may need to be reduced. Moreover, when another sample vector is added during a classification process in order to increase classification performance, a new simple training function needs to be generated. Hereinafter, the training function generating method will be described with reference to FIG. 2.

FIG. 2 is a view illustrating a training function generating device according to an embodiment of the present invention. Referring to FIG. 2, the training function generating device 100 includes an initial condition setting unit 110, a training function calculating unit 120, a loop determining unit 130, and a training function generating unit 140.

The initial condition setting unit 110 sets an initial condition in order to generate a training function. The initial function set in the initial condition setting unit 110 may include the significance and classification performance of a training function. The significance is a constant that determines a priority between False Alarm (FA) probability and Miss Detection (MD) probability. The significance will be described in more detail with reference to the following embodiment.

The training function calculating unit 120 calculates a training function having a Minimum Mean Square Error (MMSE) according to the significance on training vectors. The training function calculated by the training function calculating unit 120 may be a linear function. The training function calculating unit 120 may calculate a linear coefficient and a bias, which are multiplied to a specific vector in order to calculate a training function.

The loop determining unit 130 determines whether the classification performance of the training function, which is calculated by the training function calculating unit 120, satisfies a condition predetermined by the initial condition setting unit 110. The classification performance determined by the loop determining unit 130 may be determined on the basis of the MD probability with respect to the same FA probability. If the classification performance does not satisfy the predetermined condition, the loop determining unit 130 changes the significance, and then, requests a recalculation to the training function calculating unit 120.

If the calculated classification performance of the training function satisfies the condition predetermined by the initial condition setting unit 110, the training function generating unit 140 generates a training function according to the coefficient and bias calculated by the training function calculating unit 120.

Accordingly, the training function generating device 100 calculates a training function having the MMSE according to the significance on training vectors. Additionally, if the calculated training function does not satisfy the predetermined classification performance, the training function generating device 100 changes the significance, and then, recalculates a training function in order to further improve the classification performance. Hereinafter, the training function generating method will be described in more detail with reference to another embodiment.

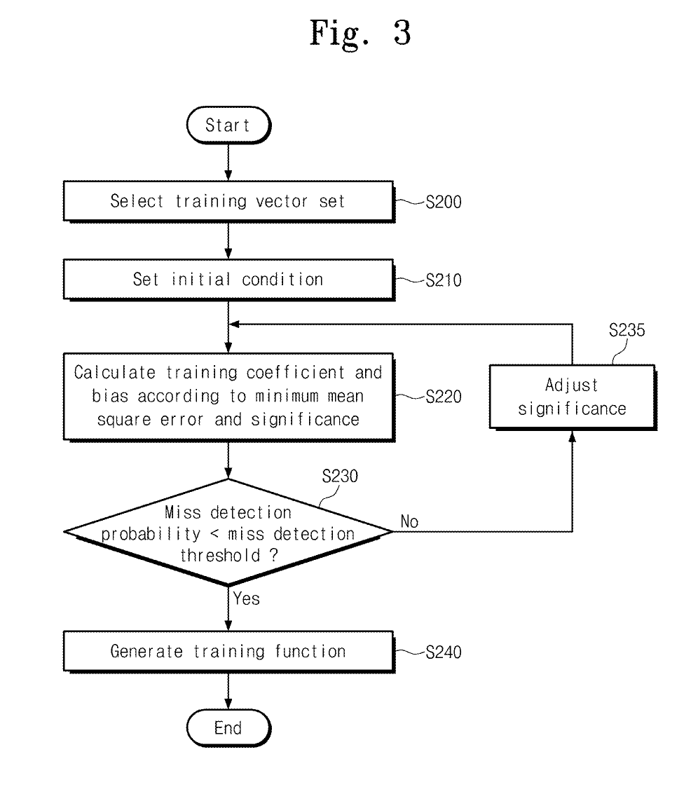

FIG. 3 is a flowchart illustrating a training function generating method according to an embodiment of the present invention. Referring to FIG. 3, a method of generating a training function using training vectors is as follows.

In operation S200, a set of training vectors used for generating a training function is selected.

X={(x₁,y₁),(x₂,y₂) . . . (xᵢ,yᵢ)},xᵢεR^{d} [Equation 3]

where xᵢ is a training vector having d features and yᵢ represents a class of a training vector xᵢ.

It is assumed that a class of training vectors is bipartite (such as positive or negative). However, this is just exemplary, and thus, the present invention is not limited to the number of classes of training vectors.

In operation S210, an initial condition for generating a training function is set. The set initial condition includes a significance and an MD threshold.

The significance is a constant that determines a priority between FA probability and MD probability. According to the significance, the probability distribution of a positive vector (a training vector having a positive class) and a negative vector (a training vector having a negative class) is changed.

Therefore, as the significance is changed, determination is made on which one of the MD probability that a positive vector is determined as a negative vector and the MD probability that a negative vector is determined as a positive vector is prioritized. The priority of the MD and FA probabilities is changed according to a situation. The significance x is expressed as the following Equation 4.

LĀ+χM B̅=0 [Equation 4]

where M is the number of positive vectors. L is the number of negative vectors. A is a set of the positive vectors. B is a set of the negative vectors.

Through this, a coefficient of Equation 4 is calculated as follows.

Ā=J_{1×M}A [Equation 5]

B̅=J_{1×L}B [Equation 6]

where J_{1×M}A is a 1×M matrix consisting of 1's and J_{1×L} is a 1×L matrix consisting of l's.

Accordingly, J_{1×M}A represents a sum vector of all positive vectors. J_{1×L}B represents a sum vector of all negative vectors.

In operation S220, a training function is calculated using the training vectors. In this embodiment, the training function is generated to have the MMSE with respect to the distribution of positive vectors and negative vectors.

The training function may have various forms. In this embodiment, the training function is expressed with the form of a linear function as shown in Equation 7. However, this is just exemplary, and thus, the present invention is not necessarily limited thereto.

f(x)=p^{T}x−b [Equation 7]

where x is a feature vector to be classified in Equation 7. p is a training coefficient calculated using the feature vector and b is a bias.

The training coefficient and bias of the training function are calculated using training vectors. Hereinafter, a method of calculating a training coefficient and a bias will be described with reference to Equation 8 to Equation 13.

A target function t according to an embodiment of the present invention is expressed as the following Equation 8.

$$t ( A , B , y , z , p , b ) = \frac{\frac{1}{M} {( \begin{matrix}Ap - \\ {bJ}_{M \times 1} - \\ y\end{matrix} )}^{T} ( \begin{matrix}Ap - \\ {bJ}_{M \times 1} - \\ y\end{matrix} ) + χ \frac{1}{L} {( \begin{matrix}Bp - \\ {bJ}_{L \times 1} - \\ z\end{matrix} )}^{T} ( \begin{matrix}Bp - \\ {bJ}_{L \times 1} - \\ z\end{matrix} )}{{( \overline{y} - \overline{z} )}^{2}} \qquad [ Equation 8 ]$$

where t represents a mean square error to given training vectors. As shown in Equation 4, A is a set of positive vectors. B is a set of negative vectors. M is the number of positive vectors. L is the number of negative vectors. χ represents a significance. y represents an expected value of a decision value of positive vectors. z represents an expected value of a decision value of negative vectors. p and b are a training coefficient and a bias as described in Equation 4. J_{1×M} is a 1×M matrix consisting of 1's and J_{1×L} is a 1×L matrix consisting of 1's.

According to this embodiment, the target function t is calculated as shown in Equation 8, and this is just one embodiment of the present invention. Thus, the present invention is not limited thereto. Equation 8 is solved and arranged to obtain Equation 9.

$$t ( A , B , y , z , p , b ) = \frac{\begin{matrix}L ( {p}^{T} {A}^{T} Ap - b {\overline{A}}_{p} - {y}^{T} AP - {bp}^{T} {\overline{A}}^{T} + \\ {b}^{2} M + {bJ}_{1 \times M} y - {p}^{T} {A}^{T} y + {bJ}_{1 \times M} y + {y}^{T} y\end{matrix}}{{ML ( \overline{y} - \overline{z} )}^{2}} + \frac{\begin{matrix}χ M ( {p}^{T} {B}^{T} Bp - b {\overline{B}}_{p} - {z}^{T} BP - {bp}^{T} {\overline{B}}^{T} + \\ {b}^{2} L + {bJ}_{1 \times L} z - {p}^{T} {B}^{T} z + {bJ}_{1 \times L} z + {z}^{T} z\end{matrix}}{{ML ( \overline{y} - \overline{z} )}^{2}} \qquad [ Equation 9 ]$$

As described above, the target function t in Equations 8 and 9 represents a mean square error. Accordingly, by calculating p and b that minimize t, a training function having the MMSE may be obtained.

$$\frac{\partial t}{\partial p} = \frac{2 \{ \begin{matrix}( {LA}^{T} A + χ {MB}^{T} B ) p + \\ ( Lb \overline{A} + χ Mb \overline{B} ) - ( {LA}^{T} y + χ {MB}^{T} z )\end{matrix} \}}{{( \overline{y} - \overline{z} )}^{2}} \qquad [ Equation 10 ]$$

Equation 10 is the derivative of the target function t of Equation 9 with respect to p. When p that minimizes t is calculated according to Equation 10 and Equation 4, it is as follows.

p=(LA^{T}A+χMB^{T}B)⁻¹(LA^{T}y+χMB^{T}z) [Equation 11]

Likewise, Equation 12 is the derivative of the target function t of Equation 9 with respect to b, and Equation 13 represents b that minimizes t.

$$\begin{matrix}\frac{\partial t}{\partial b} = \frac{L ( \begin{matrix}\overline{A} p + {p}^{T} {A}^{T} + \\ 2 bM - 2 {J}_{1 \times M} y\end{matrix} ) + χ M ( \begin{matrix}\overline{B} p + {p}^{T} {B}^{T} + \\ 2 bL - 2 {J}_{1 \times L} z\end{matrix} ) \}}{{( \overline{y} - \overline{z} )}^{2}} & [ Equation 12 ] \\ b = \frac{{LJ}_{1 \times M} y + χ {MJ}_{1 \times L} z ) \}}{ML ( 1 + χ )} & [ Equation 13 ]\end{matrix}$$

Accordingly, through the above procedures, a linear training function having the MMSE may be calculated.

Additionally, when examining Equation 11 and Equation 13, newly required coefficients are only A^{T}A, B^{T}B, A^{T}y, and B^{T}z in order to calculate p and b when a new training vector is added. These coefficients are called storage coefficients. And, a set of newly added positive vectors is called a. A set of new positive vectors having a added is called A′. Then, A′^{T}A′ is expressed according to the property of a transpose matrix as the following Equation 14

A′^{T}A′=A^{T}A+a^{T}a [Equation 14]

Likewise, a set of newly added negative vectors is called f. A set of new negative vectors having f added is called B′. Then, B′^{T}B′ is expressed as the following Equation 15.

B′^{T}B′=B^{T}B+f^{T}f [Equation 15]

Likewise, A′^{T}y′ is represented with an equation with respect to A^{T}y and a. B′^{T}z is represented with an equation with respect to B^{T}z and f.

Accordingly, in summary, the training function generating method according to this embodiment may generate a new training function by substituting a value of a stored storage coefficient with a new training vector even when the new training vector is added. Therefore, since only a storage coefficient needs to be stored without storing all existing training vectors like a typical training function generating method, in terms of a computational amount and a memory required for calculation, it is very efficient.

In operation S230, the MD probability to the predetermined FA probability is calculated for the training function calculated in operation S220. The calculated MD probability is compared with a predetermined MD threshold.

In operation S235, if the calculated MD probability is equal to or greater than the MD threshold, it is determined that an error probability is high, so that a training function is recalculated again in operation S220 after adjusting the significance.

In operation S240, if the calculated MD probability is less than the MD threshold, it is determined that classification performance is satisfied, so that a training function is generated according to the calculated result.

As examined above, since the training function generating method according to an embodiment of the present invention generates a training function having the MMSE, it has high classification performance. Additionally, since a training function generated through the training function generating method is linear, a computational amount of a process for classifying a feature vector is reduced through the training function. Moreover, even when a new training vector is added, a new training function is generated with a small computational amount and memory.

Furthermore, the training function generating method introduces the significance in a process for generating a training function. Through this, the training function generating method generates a training function having the best MD probability below a desired FA probability, so that more improved classification performance is provided.

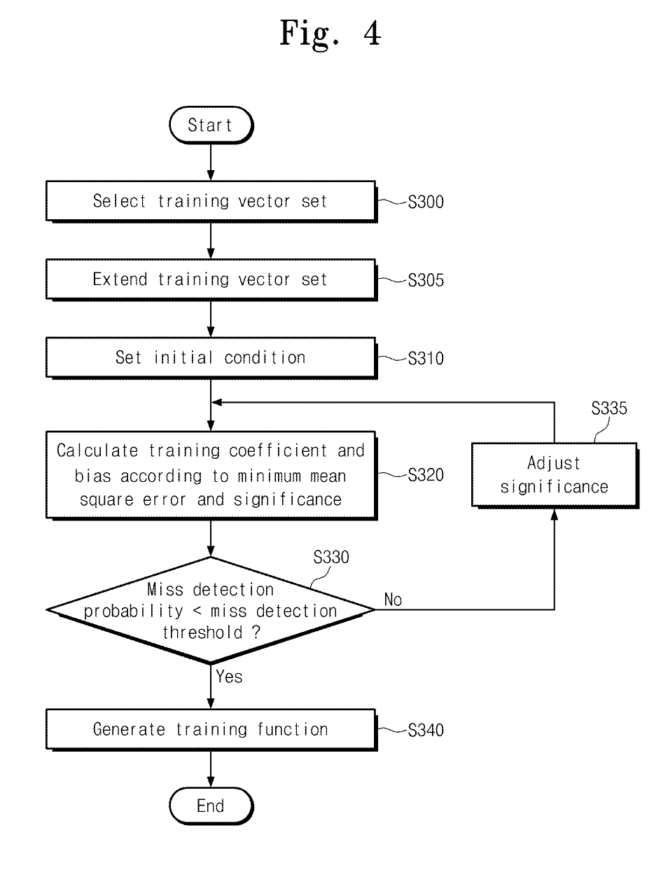

FIG. 4 is a flowchart illustrating a training function generating method according to another embodiment of the present invention. The training function generating method of FIG. 4 is identical to that of FIG. 2, except that operation S305 is added. Thus, like reference numerals refer to like elements. The overlapping operations will not be described again.

Referring to FIG. 4, in operation S305, the training vector set selected in operation S300 extends. For example, if an original training vector is [(x)], it is extended such as [(x), (x)2, (x)3, e(x), . . . ]. A training vector is extended and used without using an original training vector so that its classification performance may be improved.

As described with reference to FIG. 3, the training function generating method does not have a high complexity in a process for calculating a training coefficient and a bias. Therefore, even when a training vector is extended and used, computational complexity is not drastically increased, compared to the fact that classification performance is improved.

Referring to FIGS. 3 and 4, the classification performance of a training function according to an embodiment of the present invention is determined using the MD probability with respect to the FA probability. The probability with respect to the FA probability varies as the significance changes.

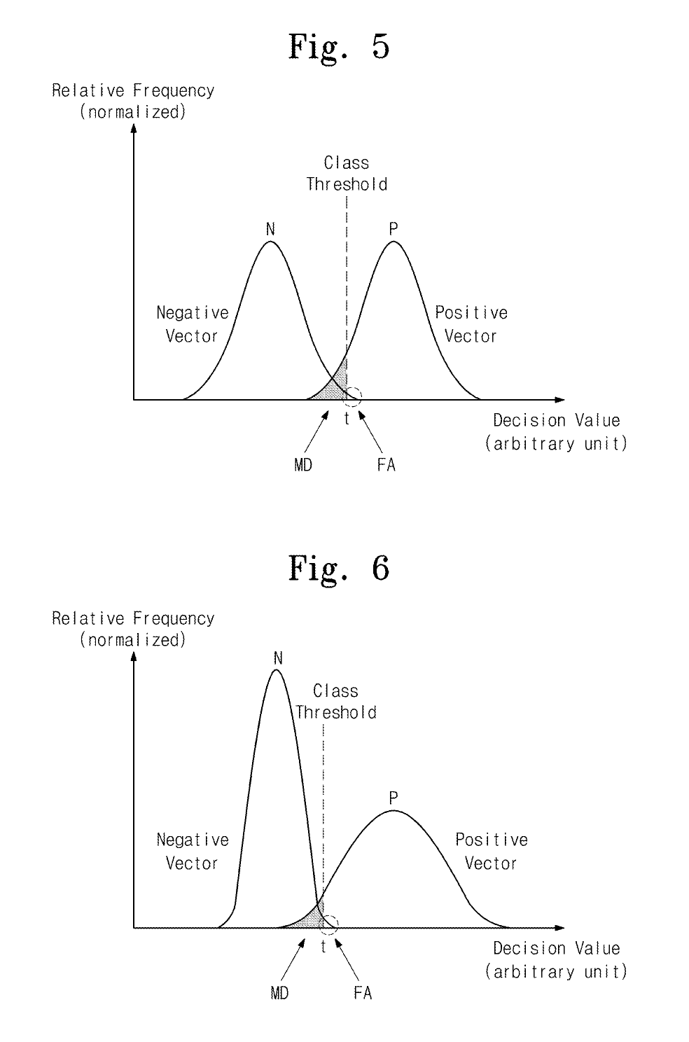

Accordingly, if the significance is changed until the calculated training function reaches a targeted classification performance, a training function having the small MD probability in addition to the FA probability less than the predetermined threshold may be generated. A method of adjusting classification performance according to the significance will be described in more detail with reference to FIG. 5. However, the MD probability with respect to the FA probability is just one example of criteria for determining classification performance, and thus, the present invention is not limited thereto.

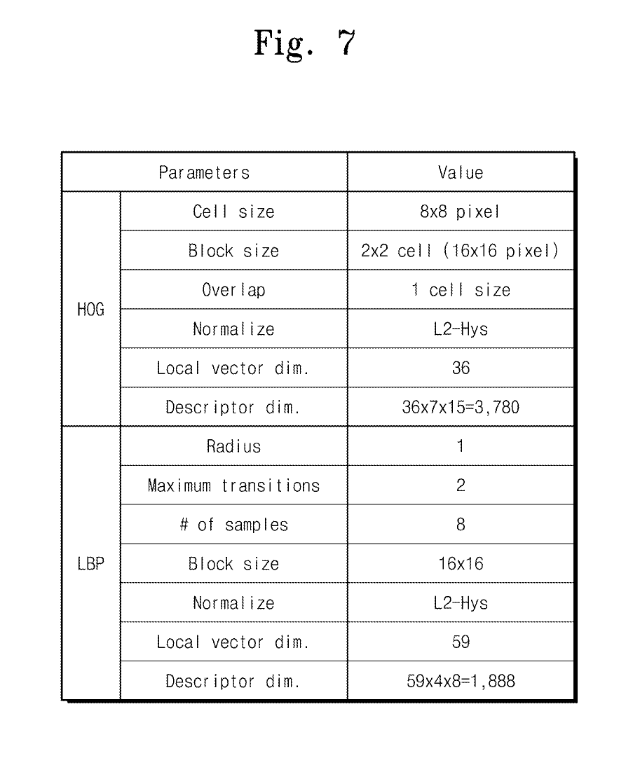

FIGS. 5 and 6 are graphs illustrating the probability distribution of training vectors. The training vectors in FIGS. 5 and 6 are identical to each other but have different significances.

A class threshold is a criterion value for determining a class. If the decision value of a vector is equal to or greater than a class threshold, a corresponding vector is determined as positive. If the decision value of a vector is less than the class threshold, a corresponding vector is determined as negative.

The FA probability is a probability that a vector for a classification target is determined as positive even if it is negative. Accordingly, the FA probability is expressed as the following Equation 16.

$$FA = {\int }_{t}^{∞} N ( x ) d x \qquad [ Equation 16 ]$$

where FA represents a FA probability, N is a probability distribution function of a negative vector. t is a class threshold. That is, the FA probability is the sum of probabilities of negative vectors having a higher decision value than the class threshold.

The MD probability is a probability that a vector for a classification target is determined as negative even if it is positive. Accordingly, the MD probability is expressed as the following Equation 17.

$$MD = {\int }_{- ∞}^{t} P ( x ) d x \qquad [ Equation 17 ]$$

where MD represents a MD probability, P is a probability distribution function of a positive vector. t is a class threshold. That is, the MD probability is the sum of probabilities of positive vectors having a lower decision value than the class threshold.

The probability distributions of a positive vector and a negative vector are determined according to the significance, and accordingly, once a class threshold is set, the FA probability and MD probability are specified.

As vectors are classified by a class, determining a negative vector as positive is far more critical than determining a positive vector as negative. Accordingly, according to this embodiment, the criterion of the FA probability is specified in advance, and then, the minimum MD probability and the specified FA probability are provided, so that classification performance may be greatly improved.

Accordingly, the MD probability is adjusted by adjusting the significance after the FA probability is specified in advance, so that optimized classification performance may be provided.

FIG. 5 is a graph illustrating the probability distribution of training vectors when a positive vector has the same significance as a negative vector. Referring to FIG. 5, the distribution of negative vectors is identical that of positive vectors.

Moreover, FIG. 6 is a graph illustrating the probability distribution of training vectors when a negative vector is prioritized. Referring to FIG. 6, it is confirmed that the probability distribution of a negative vector may be sharper than that of a positive vector.

Class thresholds of FIGS. 5 and 6 are designated to have the same pre-specified FA probability. As the class thresholds are designated, the MD probability is specified. However, the training vectors of FIGS. 5 and 6 have different probability distributions according to the significance, so that they have different MD probabilities. For example, the MD probability according to the significance of FIG. 5 is higher by about 7/2 than that according to the significance of FIG. 6.

Therefore, the training function generating method according to an embodiment of the present invention may generate a training function having an optimized MD probability with respect to a FD probability by adjusting the significance.

FIG. 7 is a table illustrating parameters, which are used for measuring computational complexity by using a HOG-LBP descriptor in order to experiment the effects of the present invention.

When looking at Histogram of Oriented Gradients (HOG) related parameters, one cell size constituting a block of the present invention is designated with 8×8 pixels. Additionally, one block size in a search window is designated with 2×2 cells, i.e. 16×16 pixels. The degree of overlap each time the search window moves is designated with one cell size.

Normalize represents a normalization factor used when a block is normalized. In this present invention, L2-Hys is used for the normalize. Additionally, a local vector dimension represents the dimension of a vector used. A descriptor dimension represents the dimension of a HOG descriptor. As shown in the table of the present invention, 36 local vector dimensions are used, and accordingly, 3780 descriptor dimensions are calculated. However, this is just exemplary, and thus, the present invention is not limited thereto.

When looking at a LBP related parameter, in relation to LBP, a radius with respect to a sample is 1; a maximum transition for determining uniformity is 2; and the number of samples is 8. The sample represents the number of neighbors with respect to the center pixel. The block size and normalization are identical to those of the HOG. A local vector dimension is 59, and accordingly, a calculated descriptor dimension is 1888.

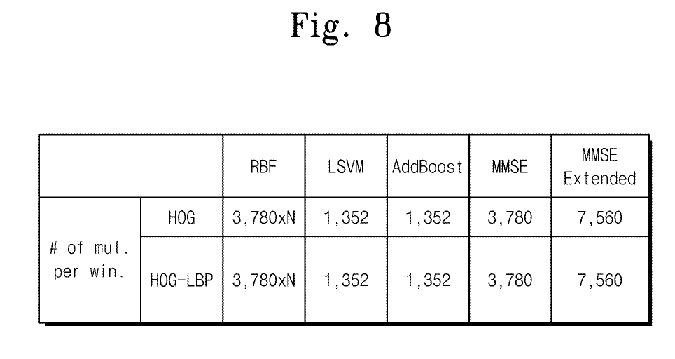

FIG. 8 is a table illustrating the number of multiplications, which is reduced when HOG and HOG-LBP descriptor are used with the parameters of FIG. 7. Here, a method according to the present invention is called the MMSE. Additionally, a method for using an extended vector according to the present invention is called MMSE Extended.

Referring to FIG. 8, it is confirmed that a training function, which is generated through the training function generating method according to an embodiment of the present invention, has higher classification performance with small computational operations than a typical Radial Basis Function (RBF), Linear Support Vector Machine (LSVM), and AddBoost method. The MMSE method of the present invention has higher classification performance than the LSVM even if it has the same small computational operations as a typical LSVM. Additionally, according to the MMSE Extended method of the present invention, as the number of training vectors used is increased, a computational amount is increased. However, the MMSE Extended method has high classification performance close to the SVM having a nonlinear kernel.

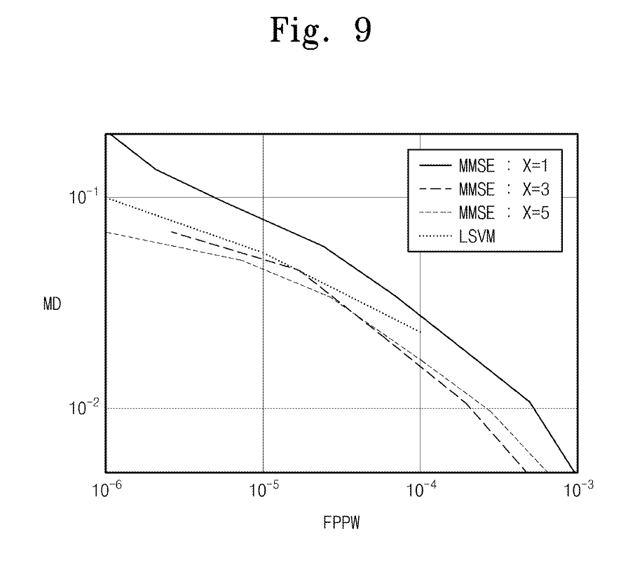

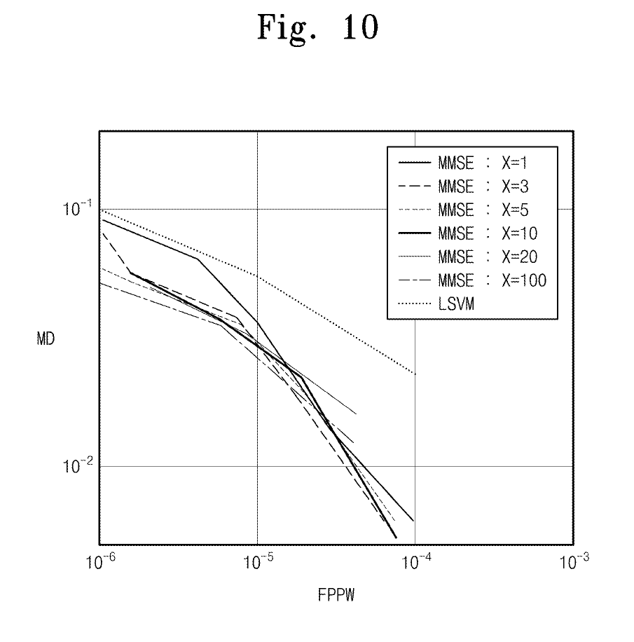

FIGS. 9 and 10 are views illustrating an experimental result of an MD rate for a False Positive Per Window (FPPW). Referring to FIGS. 9 and 10, it is confirmed that the classification method according to the present invention has more excellent classification performance than an existing LSVM method as significance is changed.

Referring to FIG. 9, the classification method according to the present invention has a large MD rate with respect to the same FA probability than the LSVM when the priority is 1, i.e. the same priority is given to the FA probability and the MD probability. However, when the priorities are 3 and 5, respectively, the classification method has a smaller MD rate than the LSVM.

Moreover, referring to FIG. 10, it is confirmed that the classification method according to the present invention has a smaller MD probability than the LSVM as a priority is increased. Accordingly, the classification method according to the present invention has more excellent classification performance than the LSVM.

The present invention provides high classification performance with lower computational amount through a training function generating device, a training function generating method, and a feature vector classifying method using the same.

The above-disclosed subject matter is to be considered illustrative, and not restrictive, and the appended claims are intended to cover all such modifications, enhancements, and other embodiments, which fall within the true spirit and scope of the present invention. For example, a detailed configuration of an initial condition setting unit, a training function calculating unit, a loop determining unit, and a training function generating unit may be diversely changed or modified according to a usage environment or purpose. Thus, to the maximum extent allowed by law, the scope of the present invention is to be determined by the broadest permissible interpretation of the following claims and their equivalents, and shall not be restricted or limited by the foregoing detailed description.

What is claimed is:

1. A training function generating method comprising:
receiving training vectors;
calculating a training function from the training vectors;
comparing a classification performance of the calculated training function with a predetermined classification performance and recalculating a training function on the basis of a comparison result,
wherein the recalculating of the training function comprises:
changing a priority between a false alarm probability and a miss detection probability of the calculated training function; and
recalculating a training function according to the changed priority.

2. The method of claim 1, wherein the classification performance of the calculated training function is determined by the false alarm probability and the miss detection probability of the calculated training function.

3. The method of claim 2, wherein the classification performance of the calculated training function is a miss detection probability when the calculated training function has a predetermined false alarm probability.

4. The method of claim 1, wherein the calculated training function is a linear function.

5. The method of claim 1, wherein the calculating of the training function uses a mean square error corresponding to the training vectors.

6. The method of claim 5, wherein the calculated function has a minimum value of the mean square error.

7. The method of claim 1, wherein the recalculating of the training function further comprises receiving new training vectors, wherein the recalculated training function is calculated from the received new training vectors according to the changed priority.

8. The method of claim 7, wherein the recalculated training function is calculated based on a storage coefficient for the training vectors and the newly added training vector.

9. The method of claim 1, wherein the calculating of the training function from the training vectors comprises:
extending the received training vectors; and
calculating the training function from the extended training vectors.

10. A feature vector classifying method comprising:
generating a training function;
calculating a decision value of a feature vector by using the generated training function; and
comparing the calculated decision value of the feature vector with a class threshold in order to classify the feature vector,
wherein the generating of the training function comprises calculating an initial training function from initial training vectors, comparing a classification performance of the initial training function with a predetermined classification performance, and recalculating a training function on the basis of a comparison result; and
the recalculating of the training function comprises changing a priority between a false alarm probability and a miss detection probability of the calculated training function, and recalculating a training function according to the changed priority.

11. The method of claim 10, wherein the recalculating of the initial training function from the initial training function comprises:
adding a new training vector; and
calculating an initial training function on the basis of a storage coefficient for the initial training vectors and the newly-added training vectors.

12. The method of claim 10, wherein the classification performance of the initial training function is determined by the false alarm probability and the miss detection probability of the initial training function.

13. A training function generating device comprising:
a training function calculating unit calculating an initial training function by using a predetermined priority;
a loop determining unit determining whether to recalculate a training function by comparing a classification performance of the initial training function with a predetermined classification performance; and
a training function generating unit outputting a training function calculated by the training function calculating unit,
wherein the loop determining unit compares the classification performance of the initial training function with the predetermined classification performance and changes the predetermine priority according to a comparison result.

14. The device of claim 13, wherein the training function calculating unit calculates the initial training function by using a mean square error corresponding to training vectors.

15. The device of claim 13, wherein the loop determining unit determines the classification performance of the calculated initial training function by using a miss detection probability of when the calculated initial training function has a predetermined false alarm probability.
